(19) United States
(12) Patent Application Publication
(10) Pub. No.: US 2008/0292840 A1
(43) Pub. Date: Nov. 27, 2008

(54) Electrically and thermally conductive carbon nanotube or nanofiber array dry adhesive

(75) Inventors: Arun Majumdar, Orinda, CA (US); Tao Tong, Sunnyvale, CA (US); Yang Zhao, El Cerrito, CA (US); Ali Kashani, San Jose, CA (US)

Correspondence Address: BUCHANAN, INGERSOLL & ROONEY PC, POST OFFICE BOX 1404, ALEXANDRIA, VA, 22313-1404, US

(73) Assignee: The Regents of the University of California, Oakland, CA (US)

(21) Appl. No.: 12/154,670

(22) Filed: May 22, 2008

Related U.S. Application Data
(63) Continuation-in-part of application No. 11/133,780, filed on May 19, 2005.
(60) Provisional application No. 60/572,713, filed on May 19, 2004.
(60) Provisional application No. 60/612,048, filed on Sep. 21, 2004.

(51) Int. Cl. B32B 5/12; C23F 1/02

(52) U.S. Cl. 428/114; 216/7; 977/742

(57) ABSTRACT

A two-sided carbon nanostructure thermal interface material having a flexible polymer matrix; an array of vertically aligned carbon nanostructures on a first surface of the flexible polymer matrix; and an array of vertically aligned carbon nanostructures on a second surface of the flexible polymer matrix, wherein the first and second surfaces are opposite sides of the flexible polymer matrix.

### RELATED APPLICATIONS

The present application is a continuation-in-part of U.S. patent application Ser. No. 11/133,780 filed on May 19, 2005, which claims priority to U.S. provisional patent application Nos. 60/572,713 filed May 19, 2004, entitled Electrically and Thermally Conductive Carbon Nanotube or Nanofiber Array Dry Adhesive; and 60/612,048 filed Sep. 21, 2004, also entitled Electrically and Thermally Conductive Carbon Nanotube or Nanofiber Array Dry Adhesive.

### TECHNICAL FIELD

The present invention relates to novel applications for carbon nanotubes and/or nanofibers.

### BACKGROUND OF THE INVENTION

Adhesives are typically wet and polymer based, and have low thermal and electrical conductivity. For many applications (including, but not limited to, electronics and semi-conductor assembly, micro-electro-mechanical systems (MEMS), and even future bio-mimicking wall-climbing robots) it would instead be desirable to provide an adhesive that is dry and detachable such that it is reusable. It would also be desirable to provide an adhesive that has high electrical and thermal conductivity to enhance electrical and/or thermal conduction across the bonding interface.

### SUMMARY OF THE INVENTION

The present invention provides a dry adhesive structure having improved thermal and electrical contact conductance. The present novel adhesive is made from carbon nanotube arrays or carbon nanofiber arrays. Such carbon nanotube arrays or carbon nanofiber arrays may optionally be made as follows.

The carbon nanostructures can be grown by chemical vapor deposition (CVD) method from a substrate surface (first surface). The substrate can be silicon, molybdenum, or other materials. An iron (Fe) layer can be used as the catalyst layer together with an aluminum (Al) and/or molybdenum (Mo) underlayer(s) to facilitate the growth. The gas feedstock is generally hydrocarbons, e.g., ethylene. The growth temperature may optionally range from 750° to 900° degrees Celsius. The density of the arrays can be controlled by the thicknesses of the catalyst layer and the underlayer(s). The height of the arrays can be controlled by the growth time. The carbon nanostructures are inherently adhered from the substrate from growth with the help of the underlayer that may optionally be made of aluminum, and/or molybdenum.

In one preferred aspect, the present invention provides a method of adhering two surfaces together with a carbon nanostructure adhesive, by: forming an array of vertically aligned carbon nanostructures on a first surface (i.e.: the “substrate surface”); and then positioning a second surface (i.e.: the “target surface”) adjacent to the vertically aligned carbon nanostructures such that the vertically aligned carbon nanostructures adhere the first and second surfaces together by van der Waals forces. In optional aspects of this method, the carbon nanotube arrays or nanofibers are deposited on the first surface by chemical vapor deposition. The density of the arrays may optionally be controlled by the thickness of a catalyst film. The height of the arrays can be controlled by the growth time.

The present carbon nanostructures preferably have a tower height of less than 30 μm, or more preferably, between 5 to 10 μm. In various embodiments, the carbon nanostructures are formed with a density of between 10¹⁰ to 10¹¹ nanostructures/cm².

In various embodiments, the carbon nanostructures are attached (adhered) to the first surface (substrate surface) by an underlayer between the bottom ends of the carbon nanostructures and the first surface (substrate surface). As stated above, this underlayer may optionally be made of aluminum, and/or molybdenum.

In another preferred aspect, the present invention provides a carbon nanostructure adhesive structure, including: a first object; an array of vertically aligned carbon nanostructures on a surface of the first object; a second object; and an array of vertically aligned carbon nanostructures on a surface of the second object. The surfaces of the first and second objects are positioned adjacent to one another such that the vertically aligned carbon nanostructures on the surface of the first object adhere to the vertically aligned carbon nanostructures on the surface of the second object by van der Waals forces.

In yet another preferred aspect, the present invention provides a two-sided carbon nanostructure adhesive structure, including: an object; an array of vertically aligned carbon nanostructures on a first surface of the object; and an array of vertically aligned carbon nanostructures on a second surface of the object, wherein the first and second surfaces are opposite sides of the object. This embodiment is particularly advantageous in adhering multiple surfaces (e.g.: different objects) together.

One advantage of the present adhesive is that it provides an adhesive that is dry. In contrast, existing adhesives are mostly wet (organic polymer-based), and difficult to handle. Furthermore, existing polymeric-based adhesives are particularly difficult to handle in vacuum (outgassing) and/or low temperature (brittle and outgassing) or elevated temperature (pyrolysis) conditions. These disadvantages are considerably overcome by carbon nanotube/nanofiber structures. They are vacuum compatible, cryogenic temperature compatible, and can also sustain an elevated temperature up to 200-300° C. in the oxygenic environment and up to at least 900° C. in vacuum environment.

Yet another advantage of the present adhesive is that it can be used at very low (i.e., cryogenic) temperatures. In contrast, existing adhesives tend to become brittle at such low temperatures.

Further advantages of the present system of using carbon nanotubes in an adhesive structure also include the fact that carbon nanotubes have very good mechanical properties such as very high Young's modulus and very high tensile, bending strengths.

Yet another advantage of the present adhesive is that it increases the levels of thermal and electrical conductance between bonding surfaces. This is especially useful in electrical applications and applications that need thermal management, e.g., chip cooling. As stated above, the present dry adhesive operates by van der Waals forces acting at the distal ends of the carbon nanostructures, thereby holding different objects or surfaces together. Such carbon nanotubes or carbon nanofibers provide excellent thermal and electrical conductance. In contrast, existing wet adhesives tend to exhibit low thermal and electrical conductance between bonding surfaces.

In another preferred aspect, a two-sided carbon nanostructure thermal interface material, comprises: a flexible polymer matrix; an array of vertically aligned carbon nanostructures on a first surface of the flexible polymer matrix; and an array of vertically aligned carbon nanostructures on a second surface of the flexible polymer matrix, wherein the first and second surfaces are opposite sides of the flexible polymer matrix.

In a further preferred aspect, a method of forming a two-sided carbon nanostructure, comprises: forming an array of vertically aligned carbon nanostructures on a rigid substrate; infiltrating the array of vertically aligned carbon nanostructures with a polymeric material; removing the rigid substrate from the array of vertically aligned carbon nanostructures and polymeric material; and etching a portion of the polymeric material to expose an array of vertically aligned carbon nanostructures protruding from a polymer film.

### BRIEF DESCRIPTION OF THE DRAWINGS

FIG. 1A is a side elevation view of a first surface (i.e.: a substrate surface which nanotubes are grown from) with an array of carbon nanostructures disposed thereon, prior to bonding to a second surface.

FIG. 1B is a side elevation view corresponding to FIG. 1A, after the first and second surfaces have been bonded together (by the carbon nanostructures on the first surface).

FIG. 2A is a side elevation view of first and second surfaces, each with an array of carbon nanostructures disposed thereon, prior to bonding the surfaces together.

FIG. 2B is a side elevation view corresponding to FIG. 2A, after the first and second surfaces have been bonded together (by the carbon nanostructures on both surfaces).

FIG. 3A is a close up perspective view of first and second bonding surfaces in FIG. 2A, each with an array of carbon nanostructures deposited thereon.

FIG. 3B is a close up sectional side elevation view of the first and second bonding surfaces of FIG. 3A placed together, showing interpenetration of the carbon nanostructures thereon.

FIG. 4A is a sectional side elevation view of a first object having an array of carbon nanostructures disposed on each of its opposite sides (prior to bonding between two other objects).

FIG. 4B is a side elevation view corresponding to FIG. 4A, after the objects have been bonded together.

FIG. 5 is an illustration of experimentally measured adhesion strength in the normal direction for various embodiments of the present adhesive structure under cyclic loading.

FIG. 6 is an illustration of experimentally measured adhesion strength in the shear direction for the various embodiments of the adhesive structure shown in FIG. 5, under cyclic loading.

FIG. 7 is an illustration of experimentally measured contact adhesion strength and contact resistivity for an embodiment of the present adhesive structure.

FIG. 8 is an illustration of experimentally measured electrical resistance properties for various embodiments of the present adhesive structure, with the bonding surfaces pushed together under various pressures.

FIG. 9 is an illustration of measured adhesion strength under cyclic loading for various embodiments of the adhesive structure as shown in FIG. 2B (i.e.: where carbon nanotubes are positioned on two opposite surfaces that are bonded together).

FIG. 10 is schematic process flow for electrically and thermally conducting adhesive tape: (a) CNT growth on Si substrate; (b) polymeric material infiltration and curing; (c) peel-off from substrate; (d) final product of the adhesive tape after controlled etching to expose CNTs protruding from the polymer film.

FIG. 11 is a perspective view of a MWCNT array grown on a Si substrate.

FIG. 12 is a perspective view of a top surface of MWCNT array coated with parylene.

FIGS. 13(a) and 13(b) are perspective views of the top surface and side view, respectively, of a MWCNT array coated with polystyrene film.

FIGS. 14(a) and 14(b) are perspective views of the top surface of a MWCNT array showing entangled structure, and a side view of a MWCNT array showing well alignment, respectively.

FIGS. 15(a)-15(c) are illustrations of a MWCNT array with an entangled top surface; a thin layer of parylene coating leads to a close-up at top; and further parylene deposition leading to piling up on the top.

FIGS. 16(a)-16(c) are illustrations of a vertically aligned CNT bundle array; the spacing between the bundles allows parylene vapor to access the CNT array from side surfaces; and an array of CNT bundles embedded in a parylene film.

FIG. 17 is a schematic representation of patterning of a metal alloy surface with a thin film of Cr and Mo to inhibit growth of carbon nanotubes.

FIGS. 18(a)-(d) are perspective views of patterned MWCNT grown directly on metal alloy substrates as follows: a) circle and b) square patterns of lower density MWNT films on NiCr substrates; c) circle and d) square patterns of high density MWCNT pillars obtained by thermal CVD on Kanthal (Fe/Cr/Al) substrates.

FIGS. 19(a) and 19(b) are schematic diagrams for adhesion strength measurement in both normal and shear directions, respectively.

FIG. 20 is an illustration of an optical mini-loading test platform for measurements of peeling strength and adhesion energy.

FIG. 21 is an illustration of an experimental configuration for thermal interface characterization.

FIG. 22 is a chart showing the relationship between the interface thermal conductance at the dry contact interface of glass-CNT and the interfacial work of adhesion.

FIG. 23 is a schematic diagram of thermal characterization of a double sided flexible CNT tape as a thermal interface material.

FIG. 24 is a schematic representation of a 4-inch thermal CVD reactor with highly controlled temperature and gas flow for the manufacturing CNT pillar array.

### DETAILED DESCRIPTION OF THE DRAWINGS

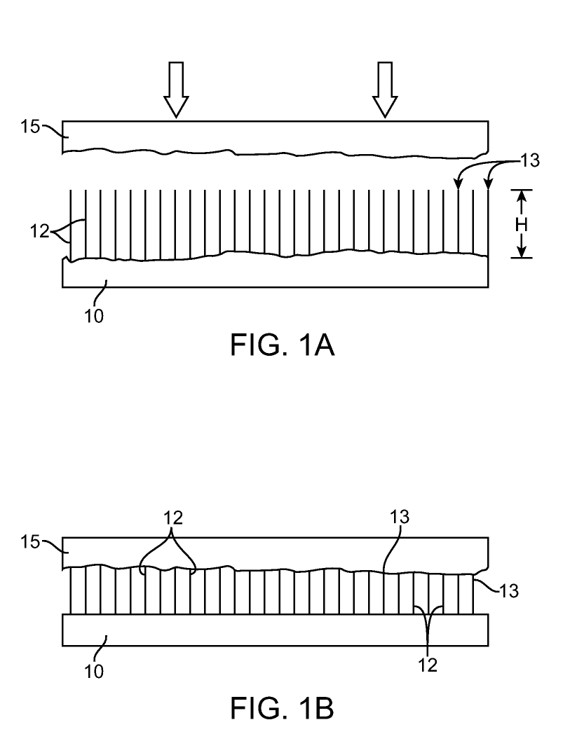

FIG. 1A shows a first bonding surface 10. An array of carbon nanostructures 12 are formed on surface 10 and extend generally vertically therefrom as shown. Carbon nanostructures 12 may be carbon nanotubes or carbon nanofibers. In embodiments where the nanostructures are carbon nanotubes, such nanotubes may be single-walled nanotubes or multi-walled nanotubes. The array of carbon nanostructures 12 may be formed onto surface 10 by standard chemical vapor deposition techniques, or by any other technique. In preferred embodiments, the density of the array of carbon nanotubes may be controlled by thickness of the catalyst layer and the underlayer(s). In optional preferred embodiments, iron is used as the catalyst film.

Next, as shown in FIG. 1B, a second surface 15 is placed on top of the array of carbon nanostructures 12. Thus, surface 15 is brought into contact with top ends 13 of carbon nanostructures 12. In accordance with the present invention, the interaction of van der Waals forces acting between top ends 13 of carbon nanostructures 12 and surface 15 will operate to bond surfaces 10 and 15 together. This bonding is due to the fact that the present carbon nanostructures 12 have a feature dimension small enough and spatial density high enough such that van der Waals interaction between carbon nanostructures 12 and surface 15 is significant rather than capillary forces.

As can be seen in FIG. 1B, some of the individual carbon nanostructures 12 may be bent slightly or even tangled around adjacent carbon nanostructures 12 (especially at their top ends 13) when surface 15 is positioned adjacent thereto. Such bending or tangling may be due to inherent surface unevenness in surface 15. In addition, surface 10 may also have slight unevenness at the location where carbon nanostructures 12 are formed thereon. Such bending or tangling at top ends 13 may also be due to differences in height among the various individual carbon nanostructures 12. The present inventors have experimentally determined that such minor microscopic variations in surface flatness on either or both of surfaces 10 and 15 do not negatively affect the performance of the present dry adhesive.

The present inventors have also experimentally determined that the present adhesive structure may exhibit enhanced bonding effectiveness when the tower height H of the individual carbon nanostructures 12 is less than 30 μm in length.

The present inventors have further experimentally determined that the present adhesive structure may exhibit enhanced bonding effectiveness when the tower height H of the carbon nanostructures 12 is specifically between 5 to 10 μm.

In various methods of manufacturing the present adhesive system, carbon nanostructures 12 may be formed onto surface 10 by chemical vapor deposition (nanotubes), or by plasma enhanced chemical vapor deposition (nanofibers). However, the present invention is not so limited. Rather, any suitable conventional technique may be used to form an array of carbon nanostructures 12 on a surface 10.

In various methods of manufacturing the present invention, carbon nanostructures 12 are formed onto surface 10 with a density of between 10¹⁰/cm² to 10¹¹/cm². It is to be understood, however, that such densities are merely exemplary, and that the present invention is not so limited.

In various methods of manufacturing the present invention, carbon nanostructures 12 are formed onto surface 10 with an underlayer therebetween. Such underlayer may comprise aluminum. The present inventors have experimentally determined that the present adhesive structure may exhibit enhanced bonding effectiveness when the underlayer comprises molybdenum. Specifically, the use of molybdenum assists in holding the bottom ends of carbon nanostructures 12 onto surface 10. This prevents carbon nanostructures 12 from separating from surface 10 if surfaces 10 and 15 are pulled in opposite directions after bonding.

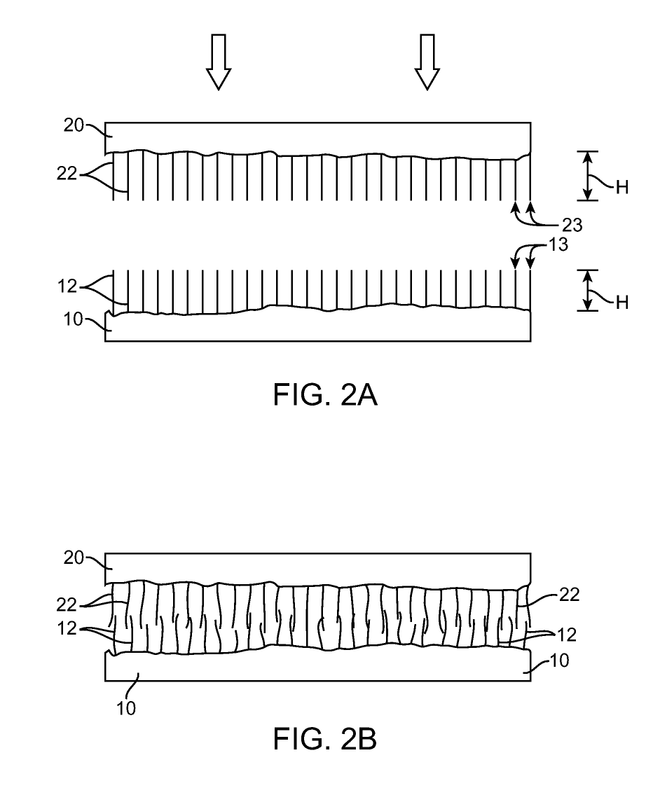

In an alternate embodiment of the invention shown in FIGS. 2A and 2B, an array of carbon nanostructures 22 is formed onto surface 20. (Carbon nanostructures 22 on surface 20 may be formed in exactly the same manner as carbon nanostructures 12 were formed on surface 10, as was explained above).

In this embodiment of the present invention, surfaces 10 and 20 are brought together as shown in FIG. 2B. The action of van der Waals forces between carbon nanostructures 12 and 22 operates to bond surfaces 10 and 20 together.

As can be seen in FIG. 2B, some of the individual carbon nanostructures 12 and 22 may be bent slightly or even tangled around adjacent carbon nanostructures 12 and 22 (especially at their respective top ends 13 and 23) when surfaces 10 and 20 are brought together. Such bending or tangling may be due to inherent surface unevenness in surfaces 10 and 20, and also be due to differences in height among the various individual carbon nanostructures 12 and 22.

As stated above, the present inventors have experimentally determined that minor microscopic variations in surface flatness on surfaces 10 and 20, and minor differences in tower height H among carbon nanostructures 12 and 22 do not negatively affect the performance of the present dry adhesive.

Moreover, in the specific embodiment of the invention shown in FIG. 2B, the top ends of carbon nanostructures 12 and 22 may interpenetrate, entangle or wrap around one another. This may further provide a “hook and loop” (e.g.: “Velcro”) type of fastening effect, further enhancing the bonding of surfaces 10 and 20 together.

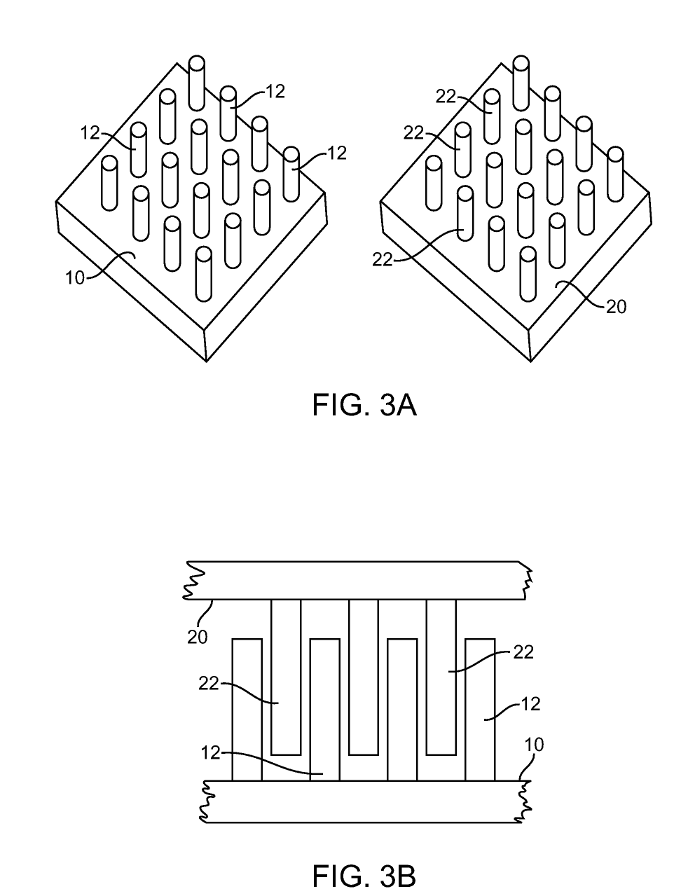

FIG. 3A shows a close up perspective view of first and second bonding surfaces 10 and 20 corresponding to FIG. 2A, each with an array of carbon nanostructures 12 and 22 deposited thereon.

FIG. 3B shows a close up view corresponding to FIG. 2B, with first and second bonding surfaces 10 and 20 positioned together, showing interpenetration of the carbon nanostructures 12 and 22 thereon. The degree of such interpenetration has been exaggerated for illustration purposes. As was explained above, such interpenetration of carbon nanostructures 12 and 22 may only consist of slight interpenetration of the top ends 13 and 23 of carbon nanostructures 12 and 22. In addition, the “pillar-like” nature of carbon nanostructures 12 and 22 has been exaggerated in FIGS. 3A and 3B for ease of illustration purposes. Typically, carbon nanostructures 12 and 22 more closely resemble long string-like structures.

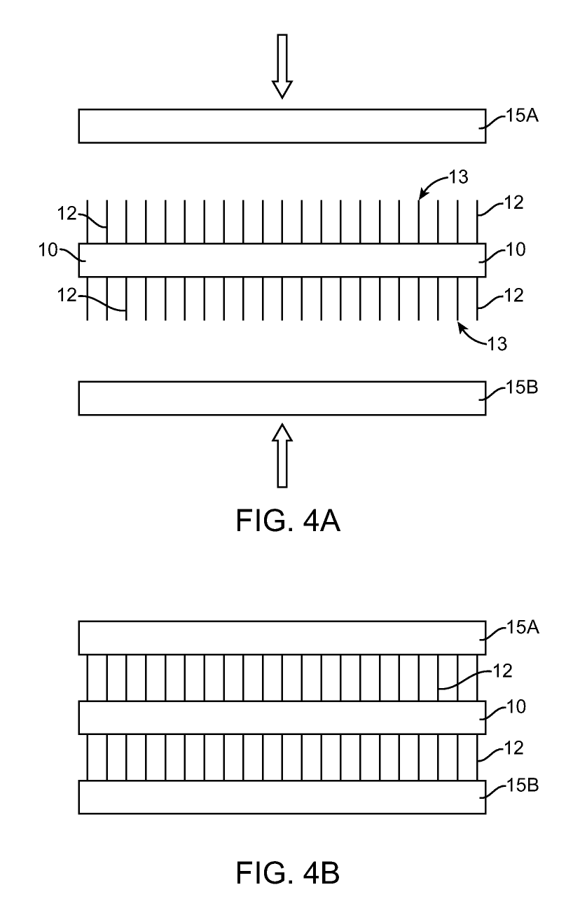

FIG. 4A shows a single bonding surface 10 with an arrays of carbon nanostructures 12 disposed on each of its opposite sides. Bonding surface 10 is received between two objects (i.e.: surfaces 15A and 15B). As was explained above, the interaction of van der Waals forces between the top ends 13 of carbon nanostructures 12 and each of surfaces 15A and 15B will operate to bond surfaces 15A and 15B together as shown in FIG. 4B. It is to be understood that the embodiment of surface 10 shown in FIGS. 4A and 4B may also be used to bond together any surfaces, including surfaces similar to 20 (i.e.: surfaces with carbon nanostructures thereon). This embodiment of the present invention is particularly useful in bonding together thin, flat electronic components due to the high electrical and thermal conductivity of the structure.

In various embodiments, each or all of surfaces 10, 15 and 20 may be silicon wafers, or they may be membranes. The present invention is not limited to any particular embodiment.

### Experimental Results

The present inventors have successfully fabricated the adhesive structures illustrated in FIGS. 1A to 3B. In one experiment, the present carbon nanotube assembly was formed by chemical vapor deposition (CVD) at a growth temperature of 750° C. with a feedstock of ethylene on highly Boron doped (10¹⁹ cm⁻³) silicon wafers. Before growth, the wafer surface was sputter-deposited with an underlayer of a ˜10 nm thick aluminum film followed by sputter-deposition of a ˜10 nm thick catalyst layer of iron. The aluminum underlayer was used to tailor the nanotubes growth and to enhance the nanotubes adhesion to the substrate. The growth time varied from 30 seconds to 10 minutes resulting in nanotube tower heights varying from a few micrometers to more than 100 micrometers.

These properties of these adhesive structures were tested both in a normal direction, and in a shear direction. Specifically, to investigate the adhesive properties of multi-walled nanotube arrays grown on Si substrates, they were pressed against the target surface with a preload of around 1 Kg. Next a lab balance was used to measure adhesion forces in both normal and shear directions.

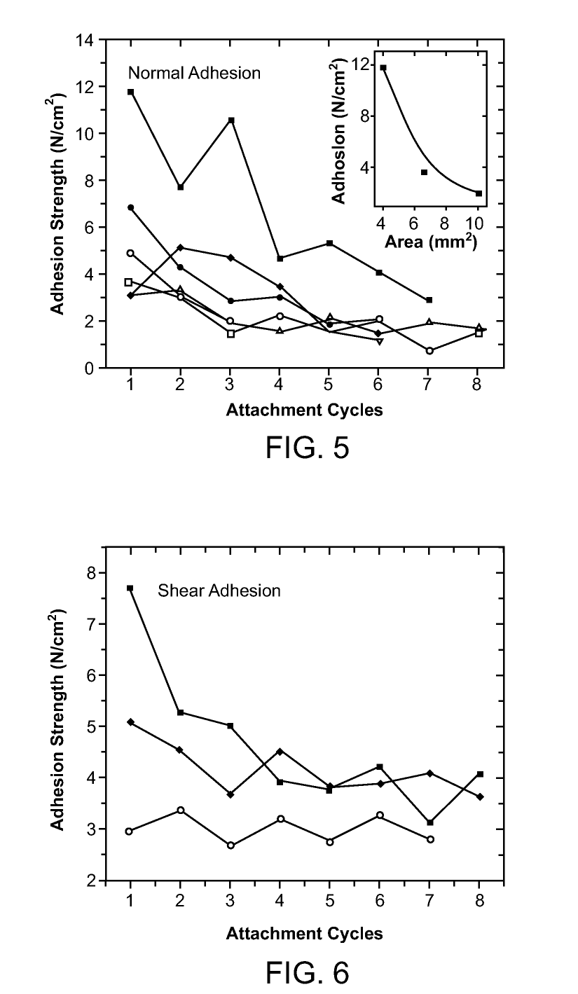

FIGS. 5 and 6 show the measured maximum normal and shear adhesion forces of the multi-walled nanotube arrays on various contacting surfaces. The carbon nanotubes in the tests were as-grown with tower heights ranging from 5 to 10 μm.

The target surfaces in FIG. 5 are illustrated as follows:

(a) glass (microscope slide)—4 mm² (solid square)
(b) glass—6 mm² (open square)
(c) gold (evaporated on Si)—4 mm² (solid circle)
(d) parylene (evaporated on Si)—7 mm² (solid diamond)
(e) GaAs—7.8 mm² (open triangle),
(f) Si—5 mm² (open circle)

The insert in FIG. 5 represents the inverse dependence of adhesion strength on contact area generalized for the glass samples.

The target surfaces in FIG. 6 are illustrated as follows:

(a) glass (microscope slide)—8 mm² (solid square)
(b) parylene—8 mm² (solid diamond)
(c) Si—8 mm² (open circle)

As can be seen in FIG. 5, the maximum measured adhesive strength in the normal direction was 11.7 N/cm² to a glass surface with an apparent area of 4 mm², and as can be seen in FIG. 6, an adhesive strength in shear of 7.8 N/cm² to a glass surface with an apparent area of 8 mm².

The present inventors have experimentally determined that tower heights of less than 30 μm show considerable adhesion, with the best results recorded at tower heights between 5 to 10 μm.

Before growth, the wafer surface was sputter-deposited with an underlayer of a ˜10 nm thick aluminum film followed by sputter-deposition of a ˜10 nm thick catalyst layer of iron. The aluminum underlayer tailored the nanotubes growth and enhanced the adhesion of the nanotubes to the substrate. The growth time varied from 30 seconds to 10 minutes resulting in nanotube tower heights varying from a few micrometers to more than 100 micrometers.

The addition of a molybdenum underlayer to the catalyst layer was found to improve the adhesion of multi-walled nanotubes 12 to surface 10.

In various experiments, a four terminal scheme was used to simultaneously measure the electrical contact conductance of the interface. Specifically, two electrodes were arranged on the back of each of surfaces 10 and 15. A constant current was applied through surfaces 10 and 15 by one set of electrodes, and the voltage drop was measured through surfaces 10 and 15 by another set of electrodes. Thus, contact and wire resistances were eliminated.

The electrical contact conductance of the multi-walled nanotube adhesive was measured to be as high as 50 Siemens per cm². Nanotube arrays covering surfaces of ˜2 mm², ˜4 mm², ˜6 mm² and ˜8 mm² were tested. The contact resistances were found to be on the order of 1 Ohm, showing no significant dependence upon contact area.

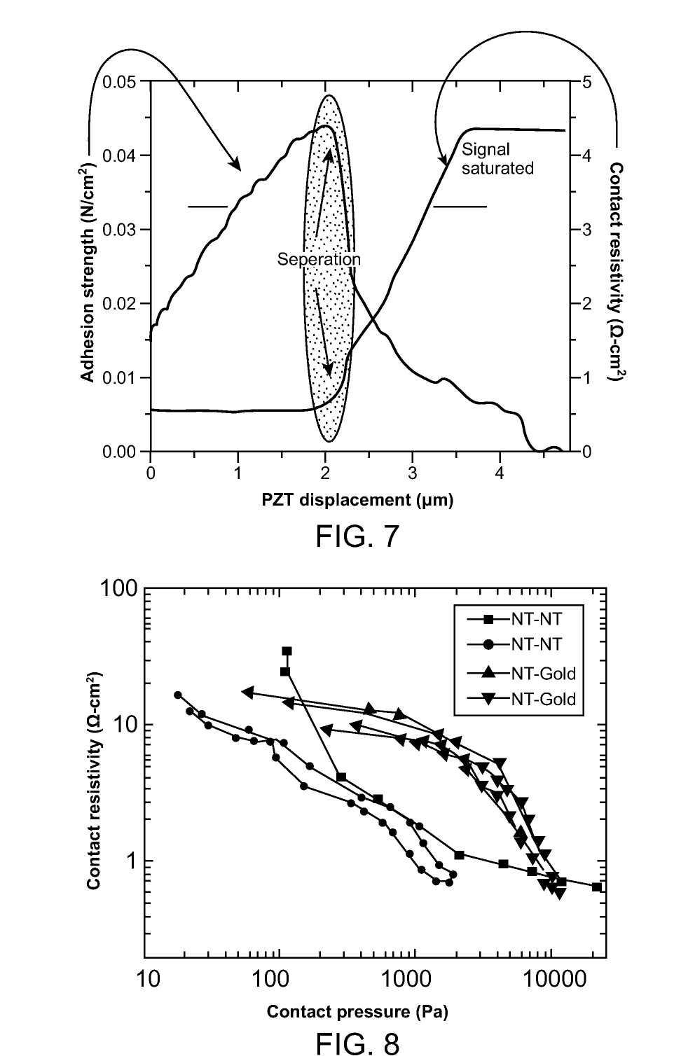

FIG. 7 is an illustration of experimentally measured contact adhesion strength and contact resistivity for an embodiment of the present invention. As can be seen, the resistivity tends to remain constant right up to the point of separation between the bonding surfaces. The bonding surfaces separate from one another at a displacement of about 2 μm (as measured experimentally by PZT displacement).

FIG. 8 is an illustration of experimentally measured electrical resistance properties for various embodiments of the present adhesive. As can be seen, resistivity tends to drop when the bonding surfaces are pushed together under greater pressures.

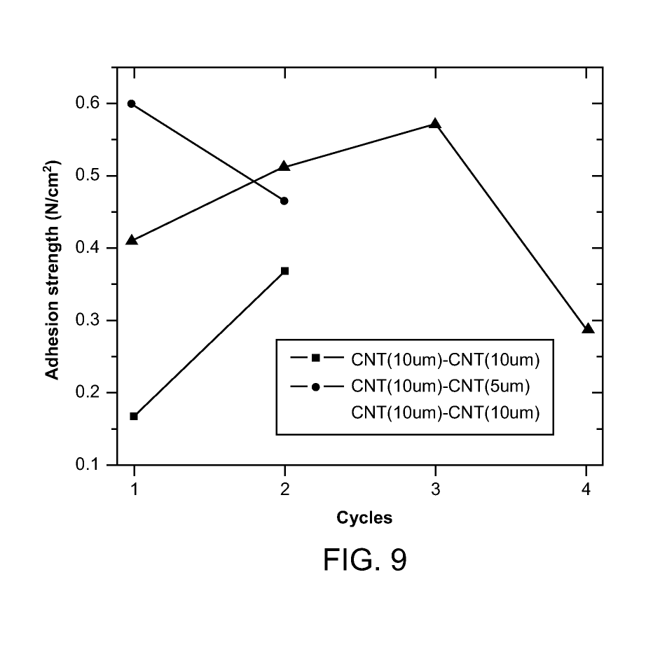

FIG. 9 is an illustration of measured adhesion strength under cyclic loading for various embodiments of the adhesive structure shown in FIG. 2B (i.e.: where carbon nanotubes are positioned on two opposite surfaces that are bonded together). As can be seen, the measured maximum adhesive strength in the normal direction was ˜0.6 N/cm² between two short carbon nanotube arrays. The bonding mechanism between the two arrays is still van der Waals force, with potentially some mechanical entangling between nanotubes (velcro-like) from the two surfaces as well.

The present inventors have calculated that: With multi-wall diameters around 20 nanometers and an aerial density around 10¹⁰ nanotubes/cm², an estimate based on the Johnson Kendall-Roberts (JKR) theory of elastic contact and surface adhesion suggests it is possible to generate adhesive strengths more than 100 N/cm² due to van der Waals attraction, assuming all the nanotubes point upward and make contact with a target surface. As has been experimentally observed, the present adhesive performs exceedingly well.

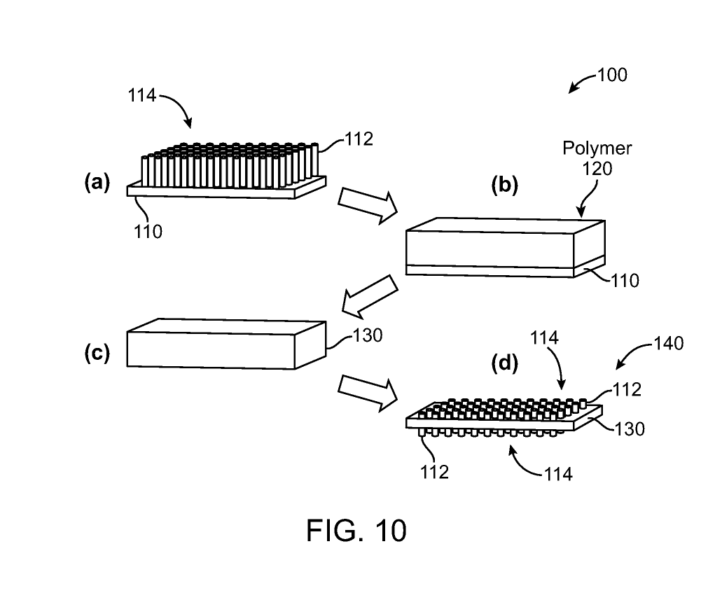

As set forth above, vertically aligned multiwalled carbon nanotube (MWCNT) array can provide strong dry adhesion force when in contact with a target surface. In addition, the adhesion effect is due to the van der Waals interaction of the carbon nanotubes (CNTs) and the target surface. In accordance with a preferred aspect or an exemplary embodiment, a two-sided carbon nanostructure adhesive 100 structure preferably comprises a versatile double-sided dry adhesive tape having vertically aligned MWCNT arrays. In accordance with an exemplary embodiment, the dry nano-adhesive tape or hybrid tape 140 is based on dense vertically aligned carbon nanotubes 112, which involve vertically aligned MWCNT arrays 114 embedded in a flexible polymer substrate or matrix 130 (FIG. 10). The hybrid tape 140 provides not only bonding strength at an interface, but also a high thermal conductance. In addition, given the fact that MWCNTs are electrically conducting, the hybrid tape 140 can also serve as an electrically conducting interface material as well.

In accordance with an exemplary embodiment, an adhesive contact (or hybrid tape) 140 as described herein has unique properties of the MWCNT array 114 including a high areal density, nanometer scale feature dimension (tube diameter), and the extraordinary mechanical, thermal and electrical properties of CNTs. The high areal density and small tube diameter lead to significant van der Waals interactions between the tube array and target surfaces. Dense vertically aligned MWCNT grown on Si substrate have strong adhesion strength with various target surfaces. However, a rigid substrate can prevent or preclude the MWCNTs from adapting to surface roughness and unevenness. Accordingly, in accordance with an exemplary embodiment, a process 100 is disclosed, which transfers the vertically aligned MWCNT array 114 grown on a rigid substrate 110 into a flexible polymer matrix 130, wherein the flexible polymer matrix 130 facilitates surface conformity and thus effective surface contact.

It can be appreciated that as a result of CNTs 112 extremely high thermal conductivity, CNT 112 are very attractive as a thermal interface material (TIM). In accordance with an exemplary embodiment, the vertically aligned MWCNT array 114 extrudes from both sides of the polymer matrix 130, which can bridge two mating surfaces and form parallel thermal paths with each path containing one CNT and two junctions at surfaces. In addition, the high density of CNT array (>10¹¹ cm⁻²) enables a high effective thermal conductance at interface.

It can be appreciated that in accordance with an exemplary embodiment, the thermal resistance of the interface between a MWCNT array grown on a Si substrate and a glass surface has been measured to be 0.013° C.-cm²/W, which outperforms all thermal interface materials presently used by an order of magnitude. The interface thermal conductance of the hybrid tape will be further improved due to better contacts facilitated by the flexibility of the substrate, which for example, can have a significant impact in the electronic packaging industry. In addition, because of the extraordinary thermal conductivity of MWCNTs (˜3000 W/m-K), the major resistance comes from the contacts between the MWCNTs and mating surfaces. However, unlike other thermal interface materials (TIMs) such as thermal grease, for which the applied film thickness is critical to its performance, the thermal performance of the hybrid tape 140 is independent of the tape thickness. Therefore, various thicknesses of the MWCNT hybrid tape can be designed to adapt to versatile industrial applications while keeping the same thermal performance.

In accordance with an exemplary embodiment, a process 100 for embedding vertically aligned MWCNT array into flexible polymer matrix 120 is disclosed. The process includes the following steps: a) growing a MWCNT array 112 on silicon (Si) substrate 110; b) achieving infiltration of parylene 120 (or alternative polymeric material) into the MWCNT arrays; and c) peeling the MWCNT embedded parylene film off from the Si substrate 110 to obtain a flexible film (i.e., polymer matrix 130).

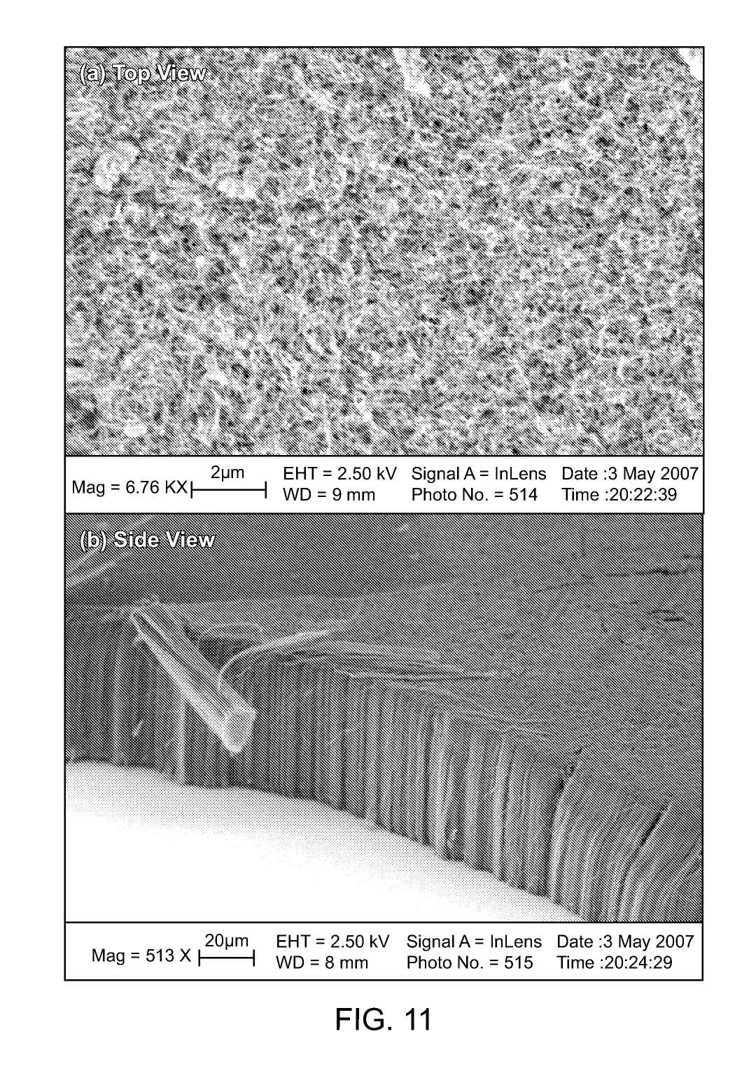

In accordance with an exemplary embodiment, a chemical vapor deposition (CVD) method can be used to grow multi-walled carbon nanotube (MWCNT) array on the Si substrate. A thin film of iron (Fe) was deposited on to Si substrate as a catalyst layer. CVD growth conditions were: growth temperature 700° C., gases: ethylene (700 sccm), hydrogen (500 sccm), Ar (1000 sccm), growth time: 10 minutes. The 10-minute process yielded a MWCNT array with height above 60 μm (FIG. 11).

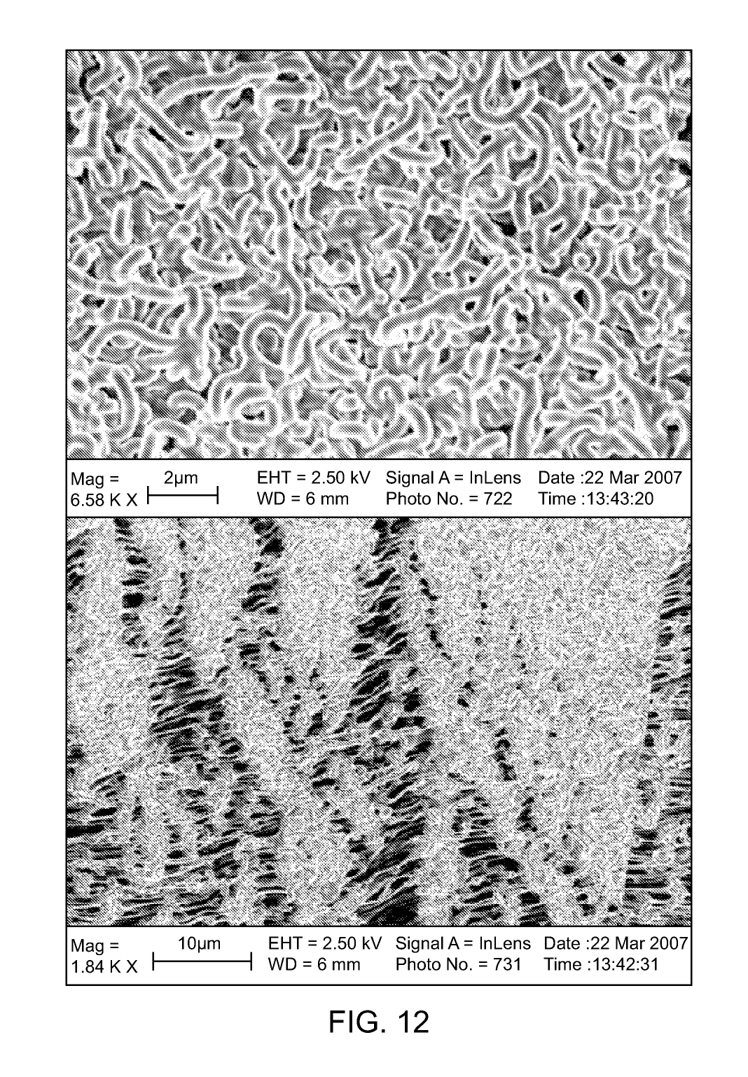

The polymer infiltration process was used to transfer the vertically aligned MWCNT array on to a flexible substrate. In accordance with an exemplary embodiment, two kinds of polymers were tested for infiltration: parylene and polystyrene. The vapor deposition of parylene is a conformal process. As shown in FIG. 12, at the top surface of the MWCNT array, the CNTs were uniformly wrapped with a parylene coating. However, since the parylene did not fully penetrate into the bottom part of the MWCNT array, only a part of the MWCNT array was embedded in the parylene film.

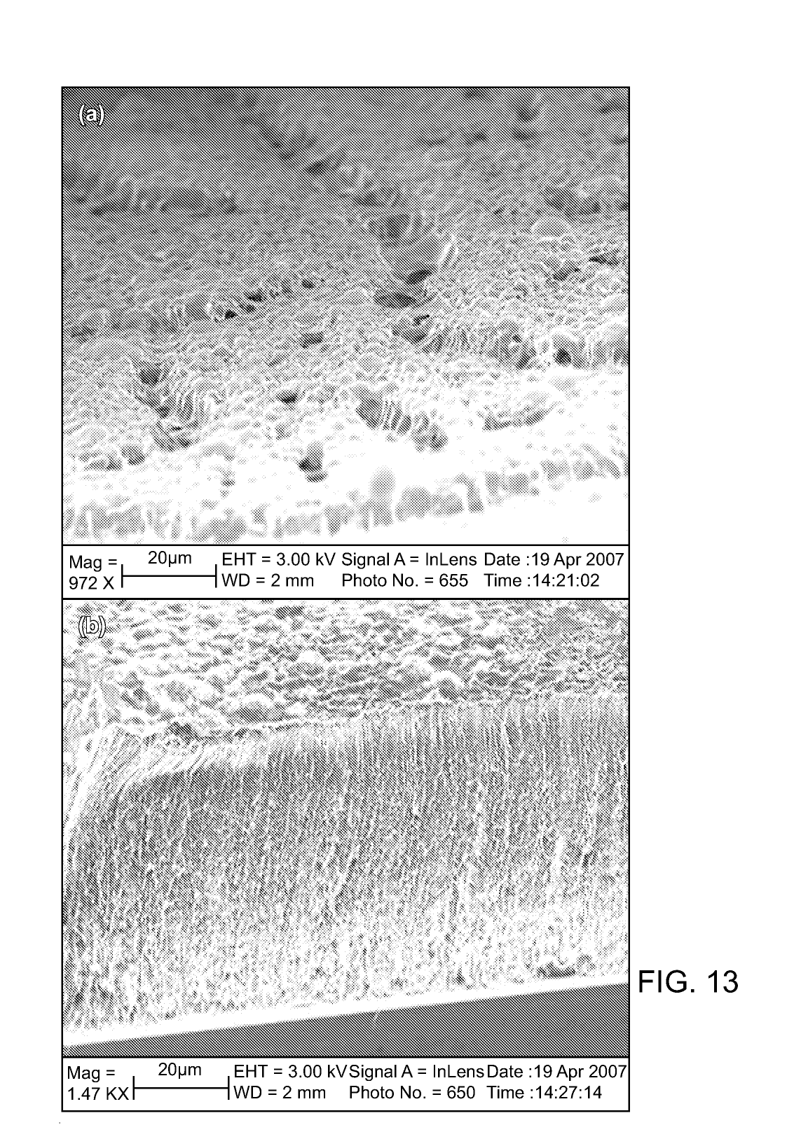

In accordance with another exemplary embodiment, polystyrene powder was dissolved in toluene, and then dispensed onto the MWCNT array on Si substrate. The MWCNT sample emerged in polystyrene solution was covered and dried at room temperature in an attempt to avoid a fast dry process, which can lead to cracks on the surface. As shown in FIG. 13, the polystyrene solution penetrated the MWCNT array thoroughly, although cracks were observed on the top surface.

It can be appreciated that in order to remove the Si substrate, the physical integrity of the polymer substrate is critical. For example, as shown in FIG. 13, for polystyrene infiltrated CNT array, cracks and voids formed in the film during the infiltration process. FIG. 12 shows a conformal coating of parylene on the top surface of a CNT array. However, since this layer was not thick enough, another layer of parylene was deposited onto the top surface. The film was carefully peeled off from the Si substrate with vertically aligned MWCNT array being embedded in the film. It was determined that because of the thickness of the parylene on the top surface, it was difficult to remove the polymer layer with the CNTs physically exposed on the top side. Therefore, during this experiment, a one-sided adhesion tape was achieved.

### Double-Sided MWCNT Tape on Polymer Substrate

In accordance with another exemplary embodiment, a double-sided CNT flexible tape was produced by the steps of: (a) transferring vertically aligned MWCNT array onto a polymer matrix in the scale of 1 cm²; (b) characterization of mechanical, adhesion and thermal performances of the tape; and (c) studying the manufacturing process to scale the size of the tape up to 4 in² (10 cm²).

In accordance with an exemplary embodiment, the process for a 1 cm² flexible CNT tape included the following steps: growing a vertically aligned MWCNT array on a rigid substrate; infiltration of a polymer or polymeric material of the MWCNT array; peeling the polymer or polymeric material form the rigid substrate; and a controlled etch of the polymer or polymeric material to expose the CNTs. Based on the work in the development of a single-sided MWCNT, the process focused on the infiltration of polymer and establishing a controlled etching process of the polymer or polymeric material in order to expose CNT on both sides of the hybrid tape.

### Polymer Infiltration:

In accordance with an exemplary embodiment, polymer or polymeric material infiltration can include vapor deposition of parylene and/or wet dispense of polystyrene.

1. Parylene Infiltration

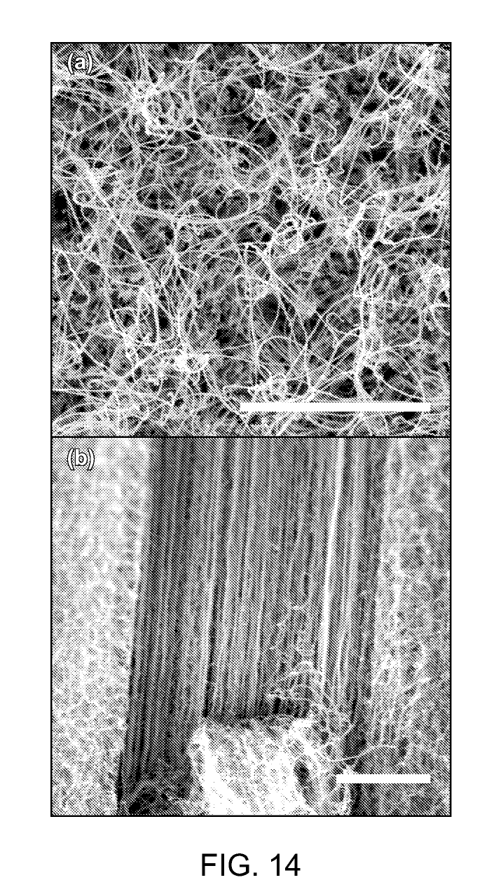

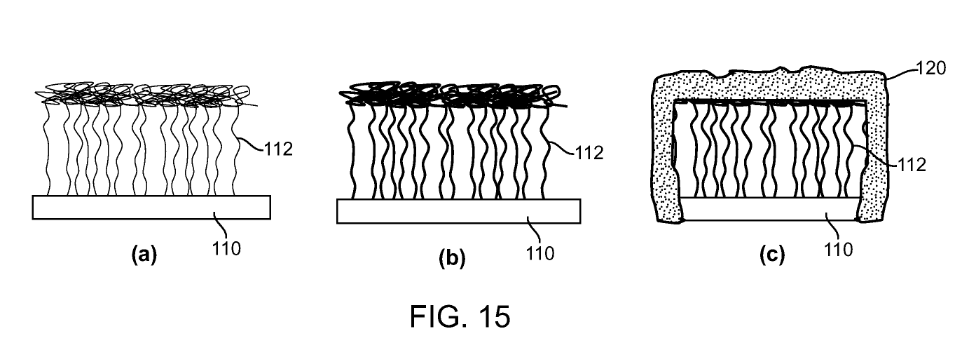

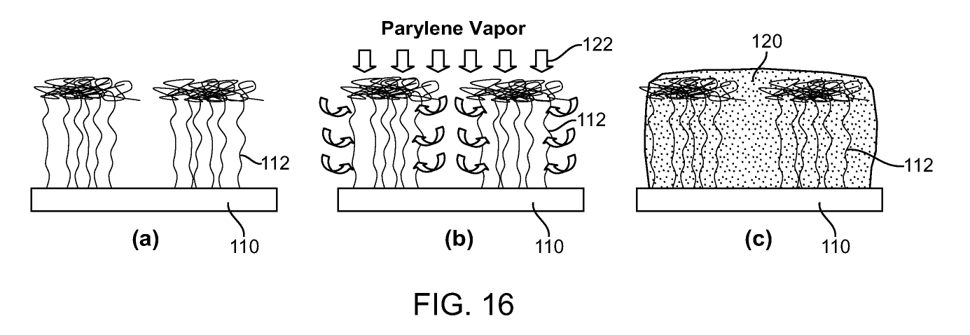

It can be appreciated that in some experiments, parylene vapor only partially infiltrated the MWCNT array. Further deposition will end up with pilling up on the top surface. This phenomenon was due to the high degree of entanglement of the CNTs on the top surface (FIG. 14(a)). As illustrated in FIG. 15, a thin coating of parylene leads to the close up on the top surface, thus shielding the bottom part of the CNT array from parylene infiltration. The side view of a MWCNT array (FIG. 14(b)) shows well alignment and clear spacing between the CNTs along the side of the array. In accordance with an exemplary embodiment, a patterned MWCNT array as shown in FIG. 16(a) contains bundles of vertically aligned MWCNT arrays. During the polymer deposition, the vapor of the parylene penetrates into the CNT bundles from not only the top surface, but also from the side of the bundle (FIG. 16(b)). The size of each bundle is at the range of tens of microns, thus ensuring a fully penetration of the parylene vapor through the bundle. In accordance with an exemplary embodiment, a thin layer (˜1 μm) of parylene film can be used to fill-in the gaps between the CNTs, and join the individual CNT bundles to form a solid continuous film, while leaving a thin layer of parylene on top (FIG. 16(c)). The thin layer of parylene on top can then be removed by controlled etching to expose the CNT surface.

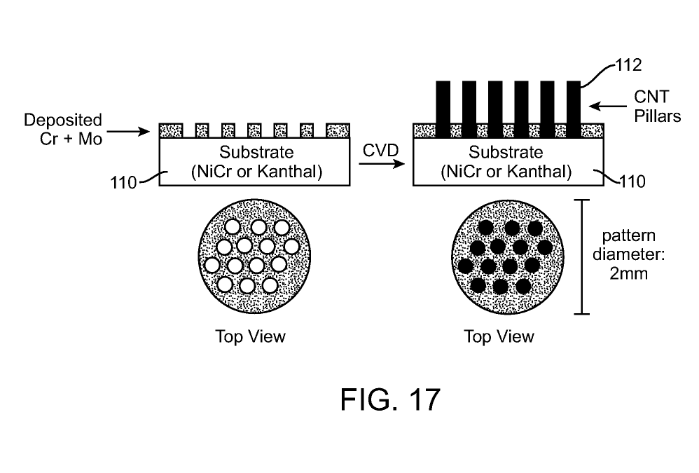

In accordance with an exemplary embodiment, the growth of bundles of vertically aligned carbon nanotubes can be performed to give individually free-standing pillar structures. It is important to note that these CNT pillar arrays should be obtained fairly easily and in a highly reproducible manner, which is important for large-scale manufacturing. In accordance with an exemplary embodiment, CNT pillar arrays of varying pillar dimensions with diameters as small as 10 μm can be fabricated with different inter-pillar spacing. For example, a photolithographic technique can be employed to define patterned metal catalysts for the fabrication of CNT pillar arrays. The CNT pillar arrays can be obtained on Si substrates with patterned metal catalyst films. Alternatively, the growth of CNTs directly on polished ultra-smooth metal alloy substrates containing Fe and/or Ni can also be achieved. FIG. 17 is a schematic representation of the patterning and subsequent CNT growth processes for generating MWCNTs.

In accordance with an exemplary embodiment, the growth process for generating the MWCNT pillar array requires heating the patterned substrates in an inert Ar gas environment to 750° C. After thermal equilibration, 1000 sccm of 80/20 etheylene/H2 gas flow results in the growth of CNT pillar arrays on patterned substrates. The height of the MWCNT pillar structures may be controlled with time of reaction.

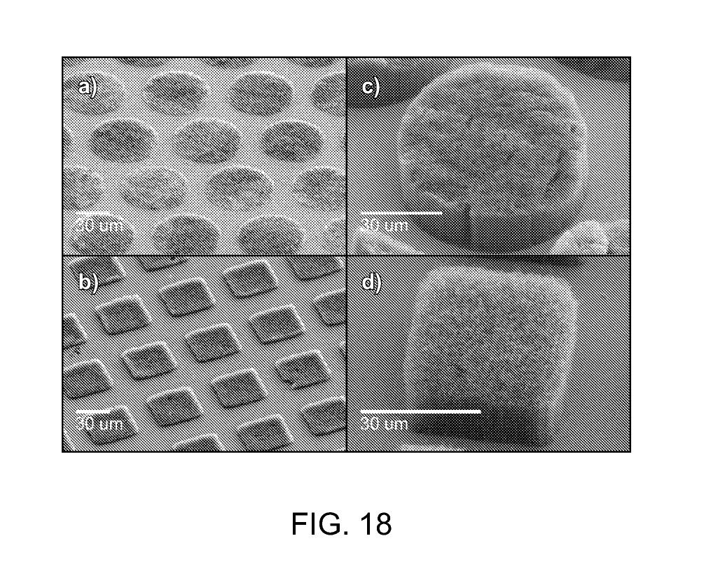

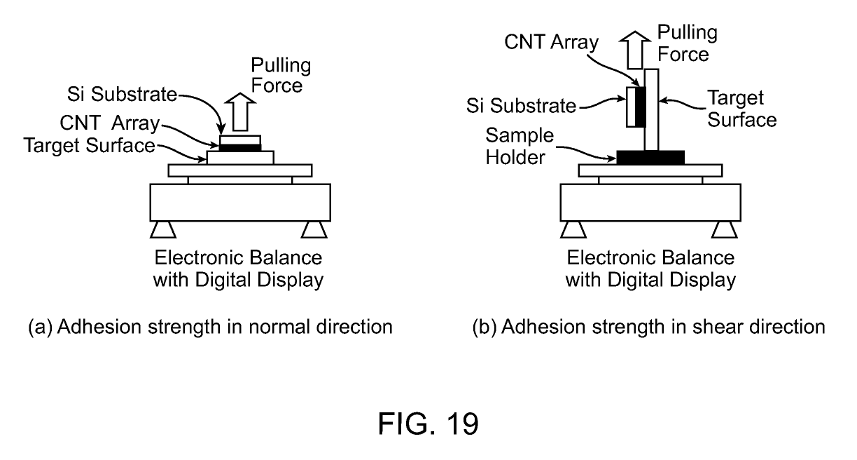

Images of CNT pillar arrays fabricated on polished metal alloy substrates are shown in FIG. 18. Low-density MWCNT growths obtained on 70/30-wt % NiCr afford patterned film, are seen in FIGS. 17(a) and 17(b), where 1-2 μm thick film of MWCNTs was observed. In comparison, high-density MWCNT growth on Kanthal, 74/24/2-wt % FeCrAl gave patterned MWCNT pillars as seen in FIGS. 17(c) and 17(d). The pillars with about 25 μm average height exhibited very high uniformity over the entire 1″ by 1″ surface area. In accordance with another exemplary embodiment, similar MWCNT pillar arrays on Si substrates using patterned Fe catalyst film were also fabricated.

It can be appreciated that in accordance with an exemplary embodiment, CNT pillar arrays of varying diameter and spacing, resulting in the ability to control the density of vertically aligned MWCNTs can be fabricated. The density of vertically aligned MWCNTs derived from the nature of the pillar array structures will significantly affect the thermal conductivity as well as the mechanical behavior of the hybrid tapes. A systematic investigation of the CNT pillar array structural parameters, such as pillar diameter, inter-pillar spacing, and pillar height was pursued in order to derive a manufacturing process for CNT-based double sided, thermally conductive adhesive tapes. In accordance with an exemplary embodiment, a larger substrate can be easily scaled up with a reactor, which is capable of CNT growth on a substrate larger than 4″ (10 cm) diameter.

2. Polystyrene Infiltration

As discussed above, it can be appreciated that in accordance with an exemplary embodiment, infiltration of polystyrene into MWCNT array can be obtained by wet dispense and curing. However, in accordance with another exemplary embodiment, the process can use the pillar array discussed previously for polystyrene infiltration, so that the polystyrene filling in the spacing between the pillars can provide a bond for the hybrid structure. With this approach the cracks during the curing process are limited to a small scale, thus greatly improving the physical integrity of the tape.

### Controlled Etch of Polymer

In accordance with an exemplary embodiment, it can be appreciated that the adhesion performance of a CNT array can be related to the array height. CNT arrays with height less than 50 μm showed adhesion and also a general improvement with shorter length. It can be appreciated that the elastic energy stored in the array during preloading can also adversely affect the adhesion interface by releasing the energy into the interface and thereby peeling it apart. The stored elastic energy during the preload process is a function of the array height and the elastic modulus of the CNT array. In accordance with an exemplary embodiment, the elastic modulus of dense MWCNT arrays on vertically aligned MWCNT arrays is around 0.25 MPa and is independent of array height, which is consistent with the conclusion of Dahlquist's studies on various kinds of tacky adhesives in that all the adhesives need to have modulus less than 0.3 MPa to show tack. The typical interface work of adhesion was characterized by a “peel-test”, and was found to be around 36 mJ/m², which is in the typical range of van der Waals interfaces. Considering a 30 μm tall CNT array with an effective modulus of 0.25 MPa, it takes only about 10% of strain to store a similar amount of elastic energy in the CNT array as the interface work of adhesion.

Accordingly, in accordance with an exemplary embodiment, since it can appreciated that as the array gets taller it is easier to store a larger amount of elastic energy in the array so that the adhesion interface becomes unstable, it is critical to control the height of the MWCNT array extruding from the polymer matrix. Oxygen plasma is an effective way to etch parylene film and polystyrene film. In accordance with an exemplary embodiment, it can be appreciated that etch rate is a function of temperature and activation energy, and that etch rate for parylene by oxygen plasma is approximately 220 nm/min. However, it can be appreciated that a zero etch rate of graphite in oxygen plasma exists, and that studies on CNT (carbon nanotubes) also indicate that the corrosion of CNT in oxygen plasma is related to the defects on the tubes. Accordingly, in accordance with an exemplary embodiment, the etching conditions of parylene and carbon nanotubes in oxygen plasma to control the height of the MWCNT array were performed.

As a thermally, and electrically conductive adhesive material, the thermal conductance, electrical conductance, and adhesion strength of the tape can be characterized as follows:

a. Adhesion Test

The characterization of the adhesion property of the MWCNT tape includes pull-off strength in both normal and shear directions, peel-off strength, and adhesion energy. In accordance with an exemplary embodiment, the pull-off adhesion strength of MWCNT arrays on Si substrates in normal and shear directions were measured. The measurement scheme is shown in FIG. 19. It can be appreciated that a similar scheme can be used for double sided polymer embedded CNT tape, wherein the tape can be sandwiched between two rigid surfaces. In accordance with an exemplary embodiment, the top surface will be pulled away at both normal and shear direction by manipulating a translation stage. The electronic balance serves as a force sensor to record the separating force.

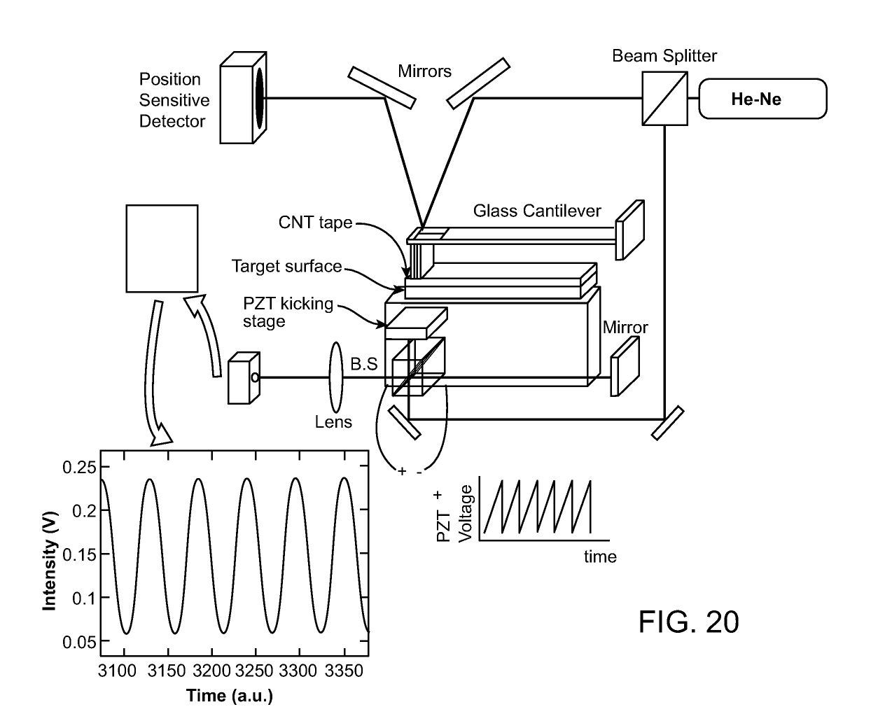

FIG. 20 illustrates a schematic diagram of peel-off strength test of the double sided MWCNT adhesive tape. The tape will be first attached to a target surface. An initial crack can be created using a razor blade. The tape will then be slowly pulled apart from the initial crack in the direction perpendicular to the adhesion plane. The adhesion force and displacement will be continuously monitored during the process by an all optical mini-loading test platform as shown in FIG. 20. The substrate is pulled down by a PZT kicking stage. The pulling force is obtained by monitoring the bending of the cantilever. The displacement of the substrate can be accurately measured by a laser interferometer. The peeling process can be also carried out to evaluate the adhesion energy at interface. When the pulling process is sufficiently slow such that it can be regarded quasi-static, at every instant during the process the elastic energy release rate with respect to the crack propagation equals the interfacial work of adhesion density required to generate the new surfaces. Thus, the total external work, which is the area under the force-displacement curve, is the total work of adhesion between the initially adhered MWCNT array and the glass surface.

b. Thermal Conductance Measurement

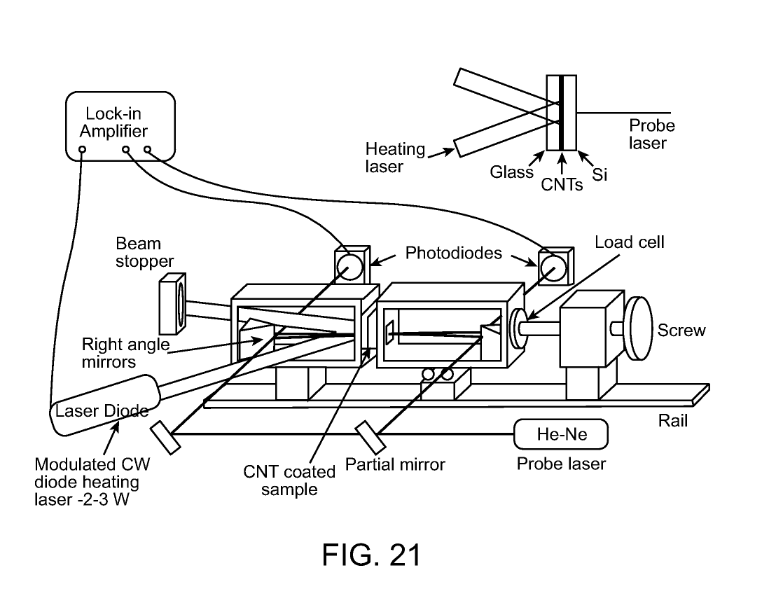

In accordance with another exemplary embodiment, the thermal performance of vertically aligned MWCNT arrays as a thermal interface material between silicon (Si) and glass surfaces was measured. The tests and/or measurements were done on as grown MWCNT arrays on a Si substrate in contact with a glass surface. A phase sensitive transient thermo-reflectance (PSTTR) technique was used to achieve the thermal properties at interface. The measurement diagram is shown in FIG. 21. The CNT-glass interface was heated by a diode laser beam with intensity sinusoidally modulated at angular frequency, ω. The diode laser beam passes through the glass plate and is absorbed at the CNT surface. The heat flux oscillation propagates through the CNT interface and then the Si substrate, causing periodic temperature oscillation at the back side of the Si substrate. A He—Ne probe laser was focused onto the back side of the Si substrate, located concentrically with the heating laser. The intensity of the reflected beam is modulated by the temperature oscillation at the back surface through the temperature dependence of reflectivity. The reflected probe beam is captured by a photo detector, and the intensity signal is sent to a lock-in amplifier to extract the signal oscillation at frequency, ω. Since the amplitude depends on the values of the reflectivity at the probe wavelength and the thermo-reflectance coefficient of the reflecting material. However, the phase of the temperature oscillation relative to heat flux oscillation is independent of these parameters (apart from signal-to-noise issue), and depends only on the thermal properties of the sample, i.e., conductivity, diffusivity, and interface conductance. Therefore, by measuring the phase of the temperature oscillation at the back surface of the Si substrate, thermal properties of the interface can be determined.

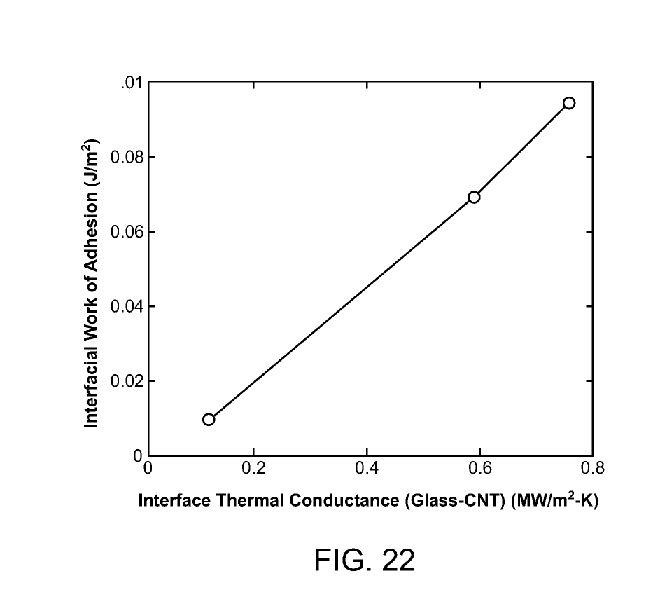

The interface thermal conductance of the MWCNT array bridging the target surface glass and grown substrate Si was measured to be in the range of 0.1 MW/m²-K. The interface thermal conductance depends on the contact quality of the CNTs at interfaces. The contact quality can be characterized by the adhesion performance. FIG. 22 shows the results of the study, which shows a strong relationship between the interface thermal conductance and adhesion energy. In accordance with an exemplary embodiment, the flexible substrate of the double sided CNT tape has a much better interfacial contact since it can easily conform to the surface curvature. Thus, a better thermal performance can be obtained with a flexible substrate over that obtained with a rigid substrate.

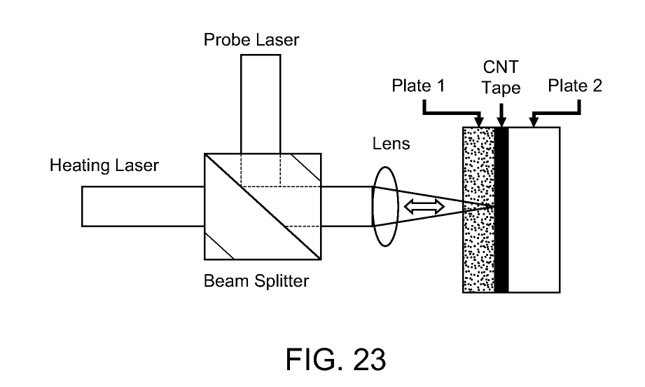

In accordance with another exemplary embodiment, the same or similar technique can be used for characterization of the double sided flexible CNT tape as a thermal interface material (TIM). As illustrated in FIG. 23, the CNT tape will be sandwiched between two rigid plates (i.e., testing surfaces). Since the measurement is an optical method, one of the plates (plate 1) was limited to glass to allow optical penetrations. The contact surface of the glass plate was coated with a gold (Au) layer to serve as a thermoreflective surface. Instead of heating at a front side and probing at the back side, the heating and probing was performed on the same side (Au on glass) to accommodate various target materials (plate 2). The absorption of modulated laser power at Au layer created a temperature fluctuation at the Au surface. The fluctuation of the temperature was a function of the thermal properties of plates 1 and 2, and also the thermal conductance of the CNT tape at the interface. Given the thermal properties of the materials of the two plates are known, a numerical simulation will be carried out using the software tool FEMLAB to fit the experimental data to achieve thermal conductance at the interfaces.

c. Electrical Conductance Measurement

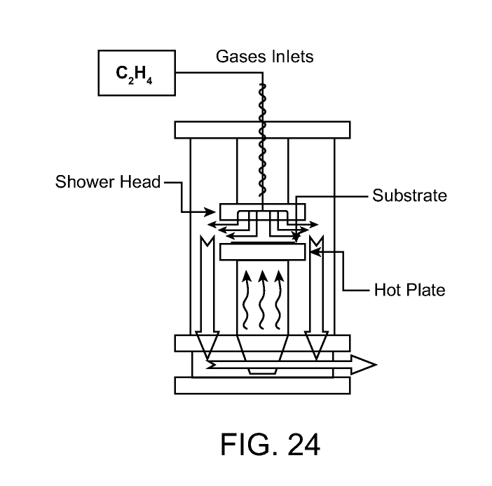

It can be appreciated that electrical conductance of the double sided flexible CNT tape can be measured by sandwiching the tape between two electrodes. In accordance with an exemplary embodiment, a cold-walled reactor composing of a precisely controlled uniform surface temperature hot plate in order to maintain consistent growth of the MWNT over the entire substrate surface for a process of manufacturing a four (4) in² Double Sided CNT Tape. In addition, the composition of the gases will also be precisely controlled by using a gas flow controller and regulators in order to achieve reproducible growth of MWCNT pillar arrays with uniform and precise length control from sample to sample. FIG. 24 shows a schematic of the thermal CVD reactor to be built for the growth of vertically aligned carbon nanotube pillar arrays for this project. The control of the temperature uniformity within the processing tube as well as the flow pattern of the reactive gases was explored, which included processing parameters for controlled growth of vertically aligned MWCNT pillar arrays also was studied and generated.

It can be appreciated that techniques for deposition and etch of polymer matrix over large surface areas up to 6″ (15 cm) in diameter are well established. Hence, in accordance with an exemplary embodiment, the process for the 1 cm² CNT hybrid tape can easily be scaled up to 4 in² (10 cm²) samples.

The above are exemplary modes of carrying out the invention and are not intended to be limiting. It will be apparent to those of ordinary skill in the art that modifications thereto can be made without departure from the spirit and scope of the invention as set forth in the following claims.

What is claimed is:

1. A two-sided carbon nanostructure thermal interface material, comprising:
a flexible polymer matrix;
an array of vertically aligned carbon nanostructures on a first surface of the flexible polymer matrix; and
an array of vertically aligned carbon nanostructures on a second surface of the flexible polymer matrix, wherein the first and second surfaces are opposite sides of the flexible polymer matrix.

2. The material of claim 1, wherein the flexible polymer matrix is parylene.

3. The material of claim 1, wherein the flexible polymer matrix is polystyrene.

4. The structure of claim 1, wherein the carbon nanostructures are carbon nanotubes.

5. The structure of claim 1, wherein the carbon nanostructures are carbon nanofibers.

6. The structure of claim 1, wherein the carbon nanostructures have a tower height of less than 30 μm.

7. A method of forming a two-sided carbon nanostructure, comprising:
forming an array of vertically aligned carbon nanostructures on a rigid substrate;
infiltrating the array of vertically aligned carbon nanostructures with a polymeric material;
removing the rigid substrate from the array of vertically aligned carbon nanostructures and polymeric material; and
etching a portion of the polymeric material to expose an array of vertically aligned carbon nanostructures protruding from a polymer film.

8. The method of claim 7, further comprising embedding the array of vertically aligned carbon nanostructures within the polymeric material.

9. The method of claim 7, further comprising curing the polymeric material before removing the rigid substrate from the array of vertically aligned carbon nanostructures and the polymeric material.

10. The method of claim 7, further comprising vaporizing the polymeric material before infiltrating the array of vertically aligned carbon nanostructures with the polymeric material.

11. The method of claim 7, wherein the polymeric material is parylene.

12. The method of claim 7, wherein the polymeric material is polystyrene.

13. The method of claim 7, wherein the step of etching away a portion of the polymeric material exposes an array of vertically aligned carbon nanostructures on a first surface of the polymer film and an array of vertically aligned carbon nanostructures on a second surface of the polymer film, and wherein the first and second surfaces are on opposite sides of the polymer film.

14. The method of claim 7, wherein the polymer film is a flexible polymer matrix.

15. The method of claim 7, wherein the rigid substrate has a patterned metal catalyst film.
